(19) United States
(12) Patent Application Publication
(10) Pub. No.: US 2007/0115331 A1
(43) Pub. Date: May 24, 2007

(54) NON-PLANAR DEFLECTION ELECTRODE IN AN INK JET PRINTER

(75) Inventors: Xuedong Zhan, Wilmette, IL (US); Pietro Lostumbo, Bloomingdale, IL (US)

Correspondence Address: MCANDREWS HELD & MALLOY, LTD, 500 WEST MADISON STREET, SUITE 3400, CHICAGO, IL, 60661, US

(73) Assignee: VIDEOJET TECHNOLOGIES INC., Wood Dale, IL (US)

(21) Appl. No.: 11/560,193

(22) Filed: Nov. 15, 2006

Related U.S. Application Data
(60) Provisional application No. 60/738,360, filed on Nov. 18, 2005.

(51) Int. Cl. B41J 2/02

(52) U.S. Cl. 347/73

(57) ABSTRACT

Embodiments of the present invention relate to a non-planar deflection electrode(s) for use with an ink jet printer. More specifically, the high voltage and/or low voltage deflection electrode of the may include a non-planar configuration. The non-planar configuration may be achieved by providing the electrode with a convex surface, which faces the ink stream and the other electrode. By using a deflection electrode that has a non-planar configuration, at least a portion of the deflection electrodes may be positioned closer together without increasing the risk of arcing. The ability to place at least a portion of the deflection electrodes closer together may increase the strength of the electric deflection field, thereby allowing the length of the deflection electrodes to be decreased without adversely affecting their ability to deflect charged ink droplets to their intended location on a substrate. Further, a non-planar configuration may also assist in the automatic cleaning of the deflection electrode(s) without having to stop the printing process.

### RELATED APPLICATIONS

This application claims priority of provisional application Ser. No. 60/738,360 filed Nov. 18, 2005, the disclosure of which is incorporated herein in its entirety.

### FEDERALLY SPONSERED RESEARCH OR DEVELOPMENT

Not applicable

### MICROFICHE/COPYRIGHT REFERENCE

Not applicable

### BACKGROUND OF THE INVENTION

Embodiments of the present invention generally relate to printing, and particularly to a non-planar deflection electrode(s) for use in a continuous ink jet printer.

Continuous ink jet printers are well known in the field of industrial coding and marking, and are widely used for printing information, such as expiry dates, on various types of substrate passing the printer on production lines. As shown in FIG. 1, a jet of ink is broken up into a regular stream of uniform ink drops by an oscillating piezoelectric element. The drops then pass a charging electrode where the individual drops are charged to selected voltages. The drops then pass through a transverse electric field (deflection field) provided across a pair of deflection electrodes. Each drop is deflected by an amount that depends on its respective charge. If a drop is uncharged, it passes through the deflection electrodes without deflection. Uncharged and slightly charged drops are collected in a catcher and returned to the ink supply for reuse. A drop following a trajectory that misses the catcher will impinge on the substrate at a point determined by the charge on the drop. Often, each charged drop is interspersed by a guard drop with substantially no charge to decrease electrostatic and aerodynamic interaction between charged drops. As the substrate moves past the printer, the placement of the drop on the substrate in the direction of motion of the substrate will have a component determined by the time at which the drop is released. The direction of motion of the substrate will hereinafter be referred to as the horizontal direction, and the direction perpendicular to this, in the plane of the substrate will hereinafter be referred to as the vertical direction. These directions are unrelated to the orientation of the substrate and printer in space. If the drops are deflected vertically, the placement of a drop in the vertical and horizontal direction is determined both by the charge on the drop and the position of the substrate.

The size and configuration of the printer head often corresponds to the size, and particularly the length, of the deflection electrodes. Therefore, a reduction in the size of the printer head may require reducing the length of the deflection electrodes. However, reducing the length of the deflection electrodes may adversely affect the ability of the deflection electrodes to properly deflect charged ink droplets. More specifically, shortening the length of the deflection electrodes may reduce the travel time of the charge ink droplets in the electric deflection field that is generated in the space between the deflection electrodes. A reduction in the time the ink droplets travel in the electric field may limit the ability of the deflection electrodes to deflect the charged ink droplets to the same degree that may be obtained with longer deflection electrodes. To compensate for the loss of deflection that may be attributed to reducing the length of the deflection electrodes, the deflection electrodes may be spaced closer together. By moving the deflection electrodes closer together, shorter deflection electrodes may be able to achieve the same, if not greater, deflection of the charge ink droplets that may be achieved with longer deflection electrodes that are spaced farther apart.

However, placing the deflection electrodes in closer proximity to each other may increase the risk of air breakdown or arcing between the deflection electrodes. When arcing occurs, the high voltage circuit is shorted, and the printer may cease operation. The risk of arcing or air breakdown between closely spaced deflection electrodes is also impacted by the humidity of the working environment. For instance, in a dry atmosphere, the electric field between the deflection electrodes may be limited to about 30 kV/cm. This value may even be lower for wet environments.

Deflection electrodes used with ink jet printers typically have a planar (or flat) inner face which face the ink drop stream. Further, it is known that electric charges typically reside on the surface of a conductor, with the charge density often being the highest at surfaces that have sharp curvatures, e.g., at the edges of the deflection electrodes. Therefore, in situations in which deflection electrodes are placed sufficiently close together so that arcing occurs, the arcing is likely to occur between the edges of the generally planar deflection electrodes.

In the past, efforts to prevent air breakdown or arcing have included configuring the ground (or low voltage) deflection electrode to be wider than the high voltage deflection electrode. By increasing the width of the ground deflection electrode relative to the high voltage electrode, the distance between the edges of the deflection electrodes may be increased, thereby potentially reducing the risk of arcing between the deflection electrodes. However, increasing the width of the ground deflection electrode requires more space in an already over-crowded printer head, and thus may limit the ability to reduce the size of the printer head.

Another attempted solution has been to place a layer of insulating material on either the high voltage or the ground deflection electrode. However, the insulating material may tend to attract micro-satellite ink droplets. Micro-satellite ink droplets may be generated when charged ink droplets break away from the stream of ink in the charging tunnel, with the micro-satellite ink droplets being 2˜3 orders of magnitude smaller than their parent charged ink droplets. The insulating material may also retain the charge associated with the micro-satellite ink droplets that accumulate on the insulating material. The accumulation of the micro-satellite ink droplets on the insulating material may also effectively reduce the strength of the deflection field between the deflection electrodes, which may thereby reduce the degree of deflection of the charged ink droplets passing between the deflection electrodes, and thus decrease the print quality of the ink jet printer.

Thus, a need exists for a system for preventing arcing between deflection electrodes that are spaced closely together. Further, a need exists for system that allows shorter deflection electrodes to achieve the same, if not greater, deflection of charged ink droplets that maybe obtained by longer deflection electrodes.

### BRIEF SUMMARY OF THE INVENTION

According to certain aspects of an embodiment of the present invention, a deflection electrode assembly is provided for use in a continuous ink jet printer of the type which projects a stream of ink drops toward a substrate and controls placement of the ink drops on the substrate by selectively charging the individual ink drops and passing the charged ink drops through an electric field created by the deflection electrode assembly. The deflection electrode assembly includes a pair of deflection electrodes positioned on opposite sides of the ink jet stream, wherein at least one of the deflection electrodes has a non-planar structure. For example, in one embodiment of the present invention, at least a portion of one of the deflection electrodes has a rounded surface (or face) which faces the ink jet stream. For example, the ground deflection electrode may have a convex surface which faces ink jet stream. The convex surface extends toward the path of the charge ink droplets and/or toward the other deflection electrode. The rounded surface may gradually peak along the centerline of the deflection electrode, whereby the space between the deflection electrodes is at its shortest at the centerline of the electrodes. The close proximity of the rounded face of the ground deflection electrode to the high voltage deflection electrode assists in creating a sufficiently strong electric deflection field between the deflection electrodes so as to allow for passing charged ink droplets to be properly deflected toward their intended location on a substrate. Further, the edges of the rounded surface may be eliminated or spaced farther from the edges of the high voltage deflection electrode, thereby reducing the potential for air breakdown or arcing between the deflection electrodes.

The non-planar configuration of the deflection electrode(s) reduces the potential for arcing and allows the deflection electrodes to be placed in closer proximity to each other without the need for insulating material. Eliminating insulating material from the deflection electrodes helps reduce the accumulation of micro-satellite ink droplets on the electrodes, which allows the deflection electrodes to operate properly for longer periods of time between cleanings.

The use of non-planar deflection electrode(s) also allows for efficient cleaning or removal of accumulated ink on the deflection electrode(s). For example, where a deflection electrode has at least a partially rounded, curved, or sloped surface that peaks away from at least one edge of the electrode, the non-planar shape of the deflection electrode surface allows cleaning fluid to flow away from the peak and across other portions of the deflection electrode surface. The ability to facilitate the flow of applied cleaning fluids across the surface of the deflection electrode allows for automated cleaning procedures to be performed without stopping the flow of the charged ink droplets through the deflection field.

### BRIEF DESCRIPTION OF SEVERAL VIEWS OF THE DRAWINGS

FIG. 1 illustrates a schematic diagram of a conventional continuous ink jet printer.

FIG. 2 illustrates a front view of conventional high voltage and ground deflection electrodes in which both the high voltage and ground deflection electrodes have a generally planar configuration.

FIG. 3 illustrates a front view of deflection electrodes in which the high voltage deflection electrode has a generally planar configuration, and the ground deflection electrode has a non-planar configuration according to an embodiment of the present invention.

FIG. 4 illustrates a front view of deflection electrodes in which the ground deflection electrode has a generally planar configuration, and high voltage deflection electrode has a non-planar configuration according to another embodiment of the present invention.

FIG. 5 illustrates a front view of deflection electrodes in which the ground deflection electrode and the high voltage deflection electrode both have a non-planar configuration according to another embodiment of the present invention.

The foregoing summary, as well as the following detailed description of the preferred embodiments of the present invention, will be better understood when read in conjunction with the appended drawings. For the purpose of illustrating the preferred embodiments of the present invention, the drawings depict embodiments that are presently preferred. It should be understood, however, that the present invention is not limited to the arrangements and instrumentality shown in the attached drawings.

### DETAILED DESCRIPTION OF THE INVENTION

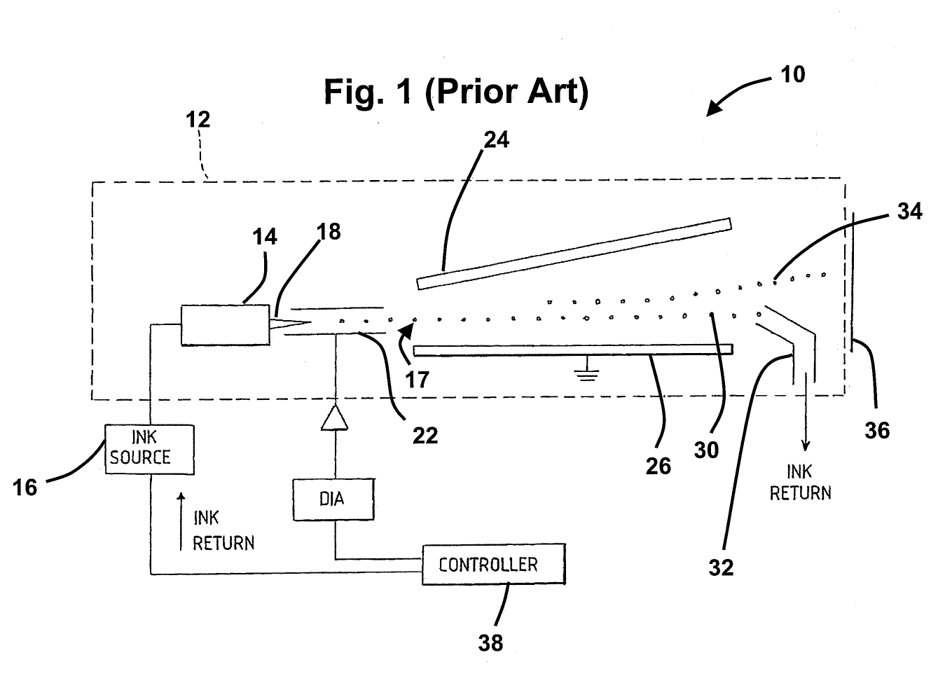

FIG. 1 illustrates a conventional continuous ink jet printer 10. The ink jet printer 10 includes a print head 12 with a drop generator 14 connected to receive ink from an ink source 16. The drop generator 14 incorporates a piezoelectric oscillator which creates perturbations in the ink flow at a nozzle 18. The nozzle 18 emits stream of uniformly sized and spaced drops. The drops pass through a charging tunnel 22, where a different charge can be selectively applied to each drop. The drops subsequently pass between a pair of opposed deflection electrodes 24, 26. A power source (not shown) is connected to the deflection electrodes 24, 26 such that a relatively uniform electric field extends between the electrodes. The charge on a given drop will determine the amount it deflects vertically as it passes between the deflection electrodes 24, 26. Insulation (not shown) may be disposed on at least one of the deflection electrodes 24, 26 to prevent arcing between the deflection electrodes 24, 26, and also between the deflection electrodes and the charging tunnel 22.

Uncharged or slightly charged drops 30 pass substantially undeflected to a catcher 32, and are recycled to ink source 16. Charged drops 34 are projected toward a substrate 36 and are deflected so as to have a trajectory striking the substrate as the substrate moves past the print head in the horizontal direction. The level of charge applied to the drop controls its vertical displacement/position on the substrate 36.

The charge to be applied to a drop is determined by a controller 38, which may be implemented by a device such as a general purpose processor, microcontroller, or embedded controller having appropriate input and output circuitry, as is well known in the art. The controller 38 operates under general program control of the instructions stored in an associated memory. The controller 38 is programmed to deliver control signals to the charge tunnel 22 to control the charges applied to the individual drops as they pass through the charge tunnel 22. The operation of such ink jet printers is well known in the art and, hence, will not be explained in greater detail herein.

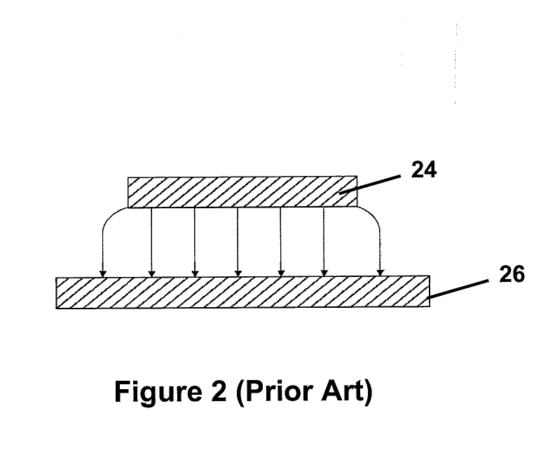

FIG. 2 illustrates a front view of conventional high voltage and ground deflection electrodes 24, 26 in which both electrodes have generally planar configurations. As illustrated, the ground deflection electrode 26 may be wider than the high voltage deflection electrode 26. As previously discussed, a ground deflection electrode that is wider than the high voltage deflection electrode may reduce the potential for arcing between the deflection electrodes. However, the relatively large width of the ground deflection electrode 24 requires more space in an already over-crowded printer head 12, and thus may adversely impact the ability to produce a smaller printer head 12.

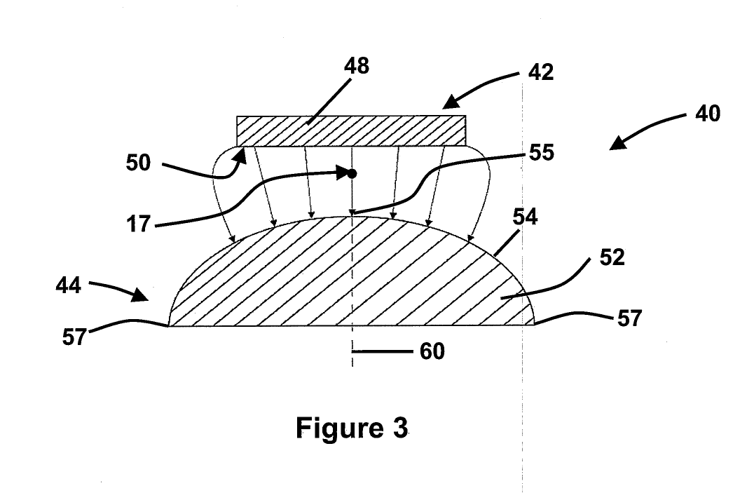

Referring to FIG. 3, a deflection electrode assembly 40 (or, also referred to as simply the electrode assembly 40) according to certain aspects of a specific embodiment of the present invention will be described in greater detail. The electrode assembly 40 is configured for use with a conventional ink jet printer, such as the printer 10 described above in FIG. 1. The electrode assembly 40 is used instead of the deflection electrodes 24, 26 shown in FIG. 1. The electrode assembly 40 is interposed between the charging tunnel 22 and the substrate 36, along the drop stream 17. In the illustrated embodiment, the deflection assembly 40 includes a high voltage deflection electrode 42, a low voltage (or ground) deflection electrode 44. A power source (not shown) is connected to the deflection electrodes 42, 44 to create a deflection field between the electrodes so that the drops are vertically deflected in relation to their individual charges. For ease of reference herein, the deflection electrodes 42, 44 may be referred to as the high voltage deflection electrode 42 and the low voltage deflection electrode 44, or simply as the high voltage electrode 42 and the low voltage electrode 44.

The high voltage electrode 42 includes a generally planar deflection plate 48 positioned above the drop stream 17, at a location between the charging tunnel 22 and the substrate 36. The high voltage electrode 42 may also include a mounting portion, not shown, for securing the high voltage electrode 42 to the frame (not shown) of the printer 10 or another mounting structure. The deflection plate 48 of the high voltage electrode 42 includes a generally planar surface 50 that faces the ink drop stream 17 and the low voltage electrode 44. (Note, the path of the ink drop stream 17 is generally perpendicular to the plane of the FIG. 3, i.e., into the drawing sheet).

In the illustrated embodiment, the ink drops are negatively charged, the high voltage deflection electrode 42 is maintained at a relatively high positive voltage potential, and the low voltage deflection electrode 44 is grounded. As a result, the negatively charged drops are deflected towards the high voltage deflection electrode 42 as they pass between the electrodes 42, 44.

The low voltage deflection electrode 44 includes a deflection plate 52 and a mounting bracket (not shown). As shown, the deflection plate 52 of the low voltage deflection electrode 44 presents a non-planar surface 54, which faces the high voltage deflection electrode 40 and the ink drop stream 17. In the illustrated embodiment, the non-planar surface is convex and rounded such that its center 55 is closer to the high voltage electrode 40 than are its edges 57. Providing a convex, the rounded surface allows for at least a portion of the low voltage deflection electrode 44 to be in close proximity to the high voltage deflection electrode 42, without causing an increase in the potential for air breakdown or arcing occurring between the edges of the deflection electrodes 40, 42. The convex construction of the deflection plate 52 also results in a deflection field that is stronger along the center line 60 of the electrodes than at the edges of the electrodes. As a result of the increased strength of the deflection field, it may be possible to reduce the length of the electrodes 42, 44, while still providing a deflection field that is capable of deflecting charged ink droplets to their intended locations on the substrate 36.

In the embodiment of the present invention illustrated in FIG. 3, the low voltage deflection electrode 42 has a convex surface whose center (or peak 55) is located in proximity to the center line 60 of the low voltage deflection electrode 44 and/or the mid section of the rounded surface. Because the path of the ink drop stream 17 passes relatively along the center of, and in close proximity to, the low voltage deflection electrode 44, placement of the peak 55 along the center line of the ground deflection electrode 42 allows the passing charged ink droplets 17 to be exposed to the strongest portion of the deflection field generated between the deflection electrodes 42, 44.

The convex, rounded construction of the non-planar surface 54 also assists in preventing the accumulation of micro-satellite ink droplets on the low voltage deflection electrode 44. More specifically, the presence of a high point 55 allows micro-satellite ink droplets that land on the non-planar surface 54 to flow away from the peak 55, and off of the non-planar surface 54.

A non-planar surface 54 also allows for efficient automatic cleaning of the deflection electrode 44. More specifically, the non-planar surface 54 of the low voltage deflection electrode 44 allows cleaning fluid that is applied or sprayed onto the non-planar surface 54 to flow away, or down from, the peak 55, and across other portions of the non-planar surface 54. The ability to facilitate the flow of cleaning fluids across the non-planar surface 54 of the low voltage deflection electrode 44 allows for automated cleaning procedures to be performed without stopping the flow of the charged ink droplets through the electric deflection field.

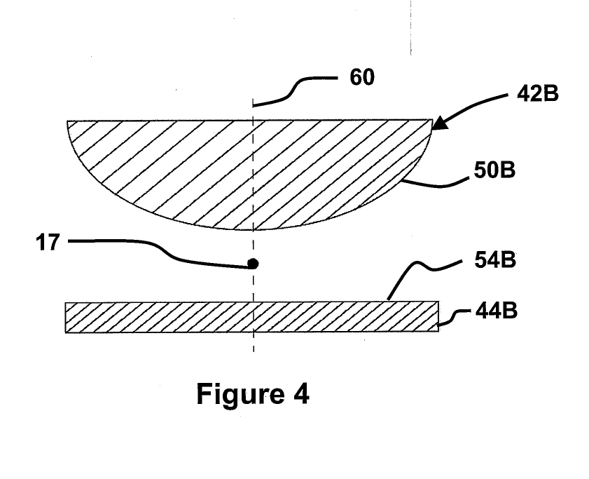

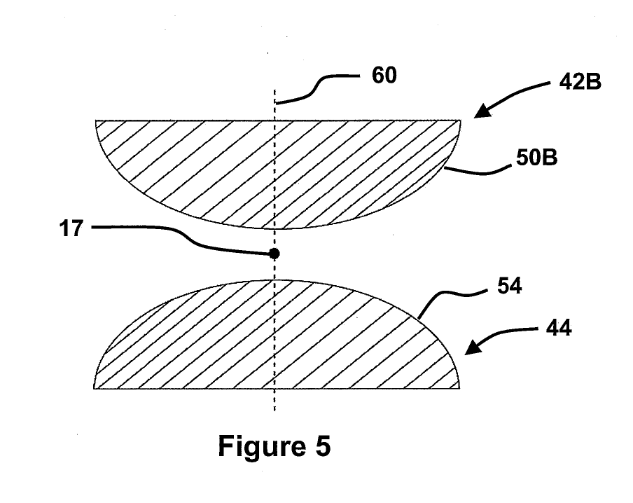

For illustration purposes, the present invention has been discussed with reference to a non-planar low voltage deflection electrode 44 and a planar high voltage deflection electrode 42. However, in alternative embodiments of the present invention, the high voltage deflection electrode may have a non-planar configuration that works in conjunction with either a planar or a non-planar ground deflection electrode. For example, FIG. 4 illustrates an alternate embodiment having a high voltage deflection electrode 42B with a non-planar surface 50B, and a low voltage defection electrode 44 has a generally planar surface 54b. Similarly, FIG. 5 shows an embodiment in which both electrodes have non-planar surfaces 50B, 54. In FIGS. 4 and 5, the high and low voltage electrodes are illustrated as having approximately the same width. However, it will be appreciated that the widths of the electrodes may be different, as discussed above. Further, although the non-planar surfaces have been illustrated as being rounded, the deflection electrode(s) of the present invention may have various other non-planar configurations, as would be readily understood by one of skill in the art.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A deflection electrode assembly for use in a continuous ink jet printer of the type which projects a stream of ink drops towards a substrate and controls placement of the ink drops on the substrate by selectively charging the individual ink drops and passing the charged ink drops through an electric field created by the deflection electrode assembly, the deflection electrode assembly comprising:
a high voltage deflection electrode positioned along the ink drop stream; and
a low voltage deflection electrode positioned along the ink drop stream opposite the high voltage deflection electrode, at least a portion of at least one of said deflection electrodes having a non-planar configuration.

2. The deflection electrode assembly of claim 1, wherein at least a portion of said high voltage deflection electrode has a non-planar configuration.

3. The deflection electrode assembly of claim 2, wherein the high voltage deflection electrode presents a convex surface facing the ink drop stream.

4. The deflection electrode assembly of claim 1, wherein at least a portion of said low voltage deflection electrode has a non-planar configuration.

5. The deflection electrode assembly of claim 4, wherein the low voltage deflection electrode presents a convex surface facing the ink drop stream.

6. The deflection electrode assembly of claim 1, wherein at least a portion of both said high voltage deflection electrode and said low voltage deflection electrode have non-planar configurations.

7. The deflection electrode assembly of claim 6, wherein the high voltage and low voltage deflection electrodes each present a respective convex surface facing the ink drop stream.

8. A deflection electrode assembly for use in a continuous ink jet printer of the type which projects a stream of ink drops towards a substrate and controls placement of the ink drops on the substrate by selectively charging the individual ink drops and passing the charged ink drops through an electric field created by the deflection electrode assembly, the deflection electrode assembly comprising:
a high voltage deflection electrode positioned along the ink drop stream; and
a low voltage deflection electrode positioned along the ink drop stream opposite the high voltage deflection electrode, at least one of the deflection electrodes having a convex surface which faces towards the other deflection electrode.

9. The deflection electrode assembly of claim 8, wherein the convex surface has a variable radius.

10. The deflection electrode assembly of claim 8, wherein the high voltage deflection electrode includes a convex surface which faces the low voltage deflection electrode.

11. The deflection electrode assembly of claim 8, wherein the low voltage deflection electrode includes a convex surface which faces the high voltage deflection electrode.

12. The deflection electrode assembly of claim 8, wherein the high voltage deflection electrode includes a convex surface which faces the low voltage deflection electrode, and wherein the low voltage deflection electrode includes a convex surface which faces the high voltage deflection electrode.

13. A method for reducing arcing between the high and low voltage deflection electrodes of a deflection electrode assembly of a continuous ink jet printer of the type which projects a stream of ink drops towards a substrate and controls placement of the ink drops on the substrate by selectively charging the individual ink drops and passing the charged ink drops through the electric field created by the deflection electrode assembly, the method comprising:
providing at least one of the deflection electrodes with a convex surface which faces towards the other deflection electrode and towards the ink drop stream.

14. The method of claim 13, further comprising providing the convex surface with a variable radius.

15. The method of claim 13, further comprising providing the high voltage deflection electrode with a convex surface which faces the low voltage deflection electrode.

16. The method of claim 13, further comprising providing the low voltage deflection electrode with a convex surface which faces the high voltage deflection electrode.

17. The method of claim 13, further comprising providing the high voltage deflection electrode with a convex surface which faces the low voltage deflection electrode, and providing the voltage deflection electrode with a convex surface which faces the high voltage deflection electrode.
